(19) United States
(12) Patent Application Publication
(10) Pub. No.: US 2023/0419743 A1
(43) Pub. Date: Dec. 28, 2023

(54) METHOD AND SYSTEM OF VEHICLE DIAGNOSTICS BASED ON KNOWN COMMUNICATION ARCHITECTURE OF THE VEHICLE

(71) Applicant: Innova Electronics Corporation, Irvine, CA (US)

(72) Inventors: Keith Andreason, Garden Grove, CA (US); Thuan Huynh, Ho Chi Minh City (VN); Ly Bach, Ho Chi Minh City (VN)

(21) Appl. No.: 17/847,946

(22) Filed: Jun. 23, 2022

(51) Int. Cl. G07C 5/00; G07C 5/08

(52) U.S. Cl. CPC G07C 5/008; G07C 5/0816; G07C 5/085; G07C 5/0808; G07C 2205/02

(57) ABSTRACT

A vehicle diagnostic method is based on an analysis of communication signals on a vehicle having a plurality of electronic control units (ECUs). The vehicle diagnostic method includes transmitting an ECU status request signal to the vehicle and receiving a status response signal from the vehicle. The status response signal includes a first group of ECUs on the vehicle that have responded to the transmitted ECU status request signal. The method additionally includes receiving communication DTCs from the vehicle, with the communication DTCs being associated with a second group of ECUs. A primary probable cause ECU is identified by comparing the second group of ECUs to the first group of ECUs, the primary probable cause ECU being included in the second group of ECUs and not in the first group of ECUs.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to automotive diagnostics, and more specifically, to automotive diagnostics which utilize known vehicle communication architecture(s) to facilitate identification of a possible fault on the vehicle.

### 2. Description of the Related Art

As a result of increased air pollution in large cities, many vehicles have utilized on-board computers to facilitate operation of electrical emission control devices since the early 1980s. However, as vehicle manufacturers have been required to comply with new emission and fuel efficiency standards, customers have also developed a desire for advanced technological features. As such, the on-board computer has evolved to accommodate these advancements.

For instance, many current on-board computer control systems are capable of providing control over many different vehicle functions and systems, such as the transmission, anti-lock brakes, electronic skid control, climate control, air bags, electric power steering, tire pressure monitoring, automatic headlights controls, keyless entry, telematics, body controls and suspension systems. Many current on-board computers include diagnostic programs to monitor input sensors, switches, actuators and facilitate communication between on-board electrical systems. Since vehicle operating conditions may quickly change, the on-board computers may continuously monitor, adjust or makes corrections with the goal of maintaining system operation within acceptable operational ranges.

Due to the increased responsibilities of the on-board computers, it became apparent that traditional hard-wired electrical systems were too heavy, bulky and expensive. Consequently, on-board computer networks were adopted, with the computer networks being capable of passing data back and forth between each other. The enhanced capabilities of on-board computer networks allowed for additional control functionalities, such as operation of exterior and interior lighting, door locks, power windows, heating and air conditioning, etc.

The on-board computers included in the computer networks are typically located throughout the vehicle, such as behind the dashboard, under the passenger's seat or the driver's seat, behind the knee and kick panels, and or at other locations that may be difficult to access. Wherever these computers are located, they may be connected to each other in some fundamental network layout and communication protocols. The incorporation of computer networks into the vehicle typically resulted in a reduction of wires, thereby reducing the complexity of the wiring commonly required to share data between the on-board computers and the vehicle's sensors and actuators. However, the interconnectedness of the computer networks resulted in an emphasis on the need for networks to remain healthy and capable of passing mission-critical data between vehicle systems. Accordingly, the diagnosis of the physical and data link layers of network communication is typically performed with expensive and complicated oscilloscopes or OEM-level scan tools. Attempting to diagnose network communication faults may be dependent on all ECUs (e.g., on board computers) being capable of detecting an issue and recording a fault code prior to being rendered unable to communicate.

While on-board computer networks vary from vehicle to vehicle, many on-board computer networks diagnose themselves in similar manners. For instance, each on-board computer may be assigned a diagnostic trouble code (DTC) set related to network DTCs, and each on-board computer may monitor communications that may occur over the network. The on-board computer may share these DTCs with querying scan tools requesting network health information. The retrieved DTCs may be displayed for the operator, although network diagnostic solutions are typically not provided. In fact, many of these tools require the user to have in-depth technical knowledge to sort through the DTCs, service information and diagnostic troubleshooting charts to arrive at a diagnostic solution. As noted above, the ability to sort through such information typically requires the end-user to be well-versed in the use the scan tool.

Therefore, there is a need in the art to be able to determine a vehicle onboard computer's operational state by interrogating, querying, parsing and classifying on-board computer network DTCs. By performing predefined programmatic calculations based off the retrieved data, a reasonable and logical diagnostic strategy and fault origin may be identified. Thus, the need for an end-user possessing vehicle on-board network fault diagnostic expertise may be vastly reduced. Furthermore, the need for multiple scan tools capable of providing level of OEM network diagnostics may be lessened. Various aspects of the present disclosure address this particular need, as will be discussed in more detail below.

### BRIEF SUMMARY

In accordance with one embodiment of the present disclosure, there is provided a vehicle diagnostic method based on an analysis of communication signals on a vehicle having a plurality of electronic control units (ECUs). The vehicle diagnostic method includes transmitting an ECU status request signal to the vehicle and receiving a status response signal from the vehicle. The status response signal includes a plurality of ECUs on the vehicle that are responsive to the transmitted ECU status request signal. A state of health report is generated and includes a comprehensive listing of all ECUs associated with the vehicle. Each ECU in the state of health report responsive to the transmitted ECU status request signal is associated with an active status, while the remaining ECUs in the state of health report being associated with an inactive status. The method additionally includes receiving communication DTCs from the vehicle, with each communication DTC being associated with at least one ECU. Identifying a primary probable cause ECU as being one of the ECUs associated a received communication DTC that is also associated with an inactive status.

The method may additionally include receiving historical DTCs from the vehicle. A secondary probable may be determined based on an analysis of the historical DTCs.

The method may additionally include generating the state of health report includes organizing all of the ECUs according to associated communication networks on the vehicle. The associated communication networks may include a powertrain network, a body network, a chassis network, and a multi-media network.

The step of receiving communication DTCs may include receiving a message error DTC, a time-out DTC and a bus-off DTC. The step of identifying a primary probable cause may include identifying a communication network or an ECU associated with a highest number of received communication DTCs.

The method may include receiving non-communication DTCs and filtering the received communication DTCs from the non-communication DTCs.

The method may also comprise requesting data associated with the probable cause.

According to another embodiment, there is provided a handheld automotive diagnostic device comprising a memory circuit having computer executable instructions stored thereon, which when executed, cause the diagnostic device to: send a status request signal to a vehicle network including a plurality of on-board computers and having a known communication architecture; receive a response signal from the vehicle network, the response signal including response information from active ones of the plurality of on-board computers; identify inactive ones of the plurality of on-board computers by comparing the active ones of the plurality of on-board computers to a comprehensive listing of the plurality of on-board computers; classify each of the plurality of on-board computers into one of a plurality of network groups, the plurality of network groups being arranged on the vehicle network to at least partially define the known communication architecture; receive fault codes from the plurality of on-board computers; categorize a network status of each fault code as being either a network type fault code or a non-network type fault code based on an origin of the fault code; and identify a probable cause based on an assessment of the network status, and the known communication architecture.

According to another embodiment, there is provided a vehicle diagnostic method based on an analysis of communication signals on a vehicle having a plurality of electronic control units (ECUs). The vehicle diagnostic method includes transmitting an ECU status request signal to the vehicle and receiving a status response signal from the vehicle. The status response signal includes a first group of ECUs on the vehicle that have responded to the transmitted ECU status request signal. The method additionally includes receiving communication DTCs from the vehicle, with the communication DTCs being associated with a second group of ECUs. A primary probable cause ECU is identified by comparing the second group of ECUs to the first group of ECUs, the primary probable cause ECU being included in the second group of ECUs and not in the first group of ECUs.

The method may additionally include the steps of receiving historical DTCs from the vehicle, and determining a secondary probable cause based on an analysis of the historical DTCs.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a schematic diagram of an exemplary communication network overlaid on a top view of a vehicle;

FIG. 2 is an electrical schematic of a communication network on the vehicle;

FIG. 3 is a chart depicting an exemplary Powertrain portion of the state-of-health;

FIG. 4 is a chart depicting an exemplary Body portion of the state-of-health;

FIG. 5 is a chart depicting an exemplary Chassis portion of the state-of-health;

FIG. 6 is a chart depicting an exemplary Multimedia portion of the state-of-health;

FIG. 7 is a chart depicting an exemplary received Message Error DTC;

FIG. 8 is a chart depicting exemplary received Time-Out DTCs;

FIG. 9 is a chart depicting exemplary received Bus-Off DTCs;

FIG. 10 is single chart combining all of the DTCs shown in FIGS. 7-9 to illustrate how a primary probable cause may be determined;

FIG. 11 shows information leading to a component primary cause of the ECM;

FIG. 12 shows information leading to a network primary cause of the Powertrain network;

FIG. 13 is an exemplary chart, which shows possible secondary probable causes of the Powertrain network, an open/short power/ground, charging system, battery and/or ignition; and

FIG. 14 is an exemplary flowchart associated with one embodiment of a vehicle diagnostic method based on analyzing communication signals on a vehicle network.

Common reference numerals are used throughout the drawings and the detailed description to indicate the same elements.

### DETAILED DESCRIPTION

The detailed description set forth below in connection with the appended drawings is intended as a description of certain embodiments of a vehicle diagnostic system and method and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure generally relate to the analysis of communication signals on the various vehicle communication networks included on a vehicle under test to try and identify a possible cause of an issue on the vehicle. In this regard, diagnostic data received from the vehicle may be analyzed in the context of the known electrical architecture of the vehicle to try and pinpoint where a root fault or problem may be occurring. When data is received from the vehicle, the data may reflect several different issues, such as network level faults, component level faults, time-out errors, etc. In some instances, there may be interaction between various systems or components, and thus, if one component or system has an issue, there may be a trickle-down effect on the downstream components or systems. In this regard, otherwise healthy components or systems may be associated with error codes or messages due to issues occurring in upstream or related components/systems.

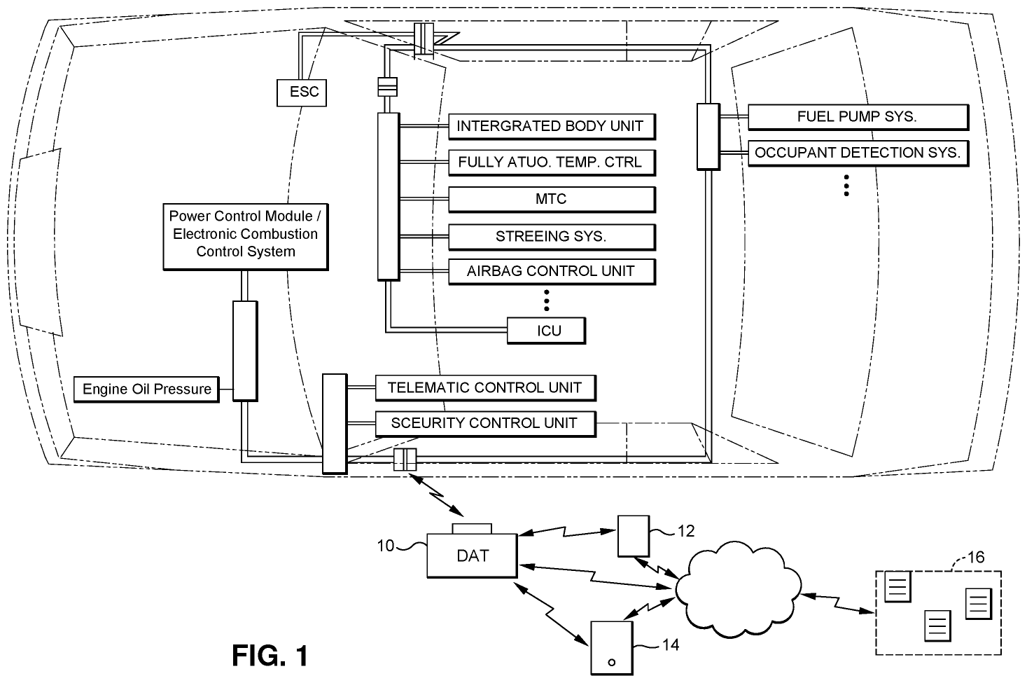

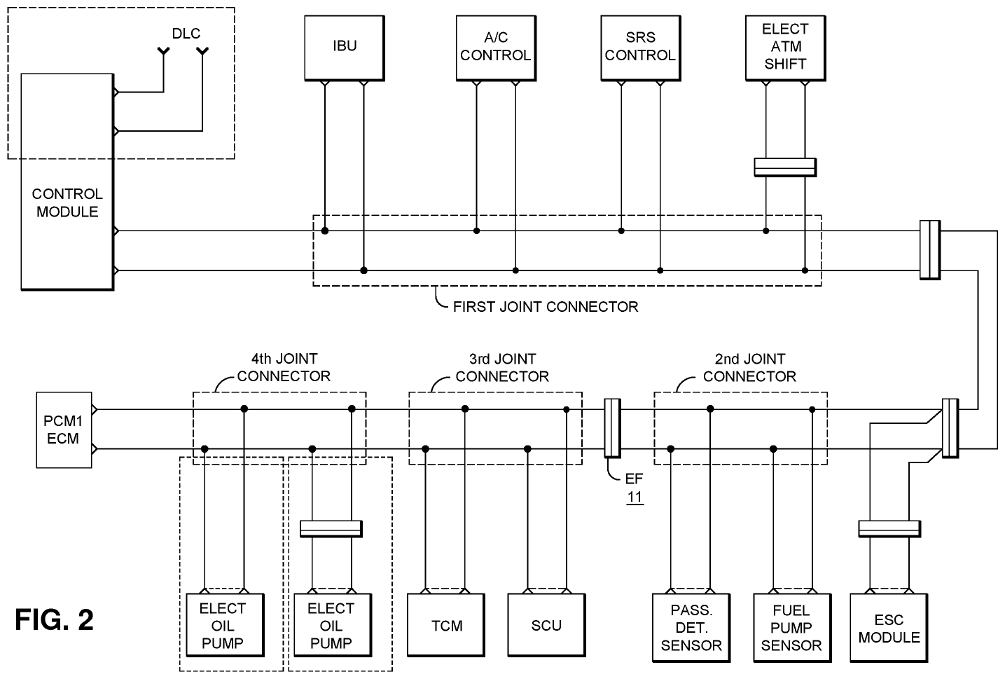

Referring now to FIGS. 1 and 2, there is depicted exemplary views of a P-CAN (Powertrain Controller Area Network) for a vehicle. In this regard, it is understood that a given vehicle communication network may include several sub-networks, including the Powertrain network, Body network, Chassis network, and Multimedia network, among others. It is understood that various vehicles may have different network groups, and that the scope of the present disclosure is not limited to any specific number or type of network groups. FIGS. 1 and 2 show the exemplary P-CAN network simply to illustrate a general layout or architecture of various electrical components in a given P-CAN network, and are not intended to be a thorough depiction of a P-CAN network. The layout of the exemplary P-CAN network is such that the IBU, A/C Control Module, SRS Control Module, and Electronic ATM Shift Lever are all connected via a common first joint connector. The Fuel Pump Control Module and Passenger Occupant Detection Sensor are connected via a common second joint connector. The TCM and SCU are connected via a common third joint connector, and a pair of Electronic Oil Pumps are connected via common fourth joint connector. The first, second, third, and fourth joint connectors are arranged in series with each other, with the data link connector (DLC) (e.g., the diagnostic port) being upstream of the first joint connector. Thus, any communication between the data link connector and the second, third, and fourth joint connectors must pass through the first joint connector. Accordingly, if there is a problem with the first connector, the entire P-CAN module may generate faults or be non-responsive. However, the issue may simply relate to the first joint connector. If the first joint connector is fixed, and the system is tested again, all faults may go away. Similarly, if the received diagnostic data shows there are issues with the TCM, SCU, and the Electronic Oil Pumps, then the shared hardware may be the location of the root problem. In this instance, the root problem may relate to EF11 or the third joint connector.

According to various aspects of the present disclosure, the method entails requesting diagnostic data from a vehicle network using a data acquisition and transfer device (DAT) 10. The DAT 10 may refer to any device capable of communicating with a vehicle network, either directly or indirectly (e.g., such as through a diagnostic port). The DAT 10 may include, but is not limited to a scan tool, a code reader, a dongle, a handheld communication device, or other hardware known by those skilled in the art. The DAT 10 may include a connector port (e.g., an OBD-2 connector port) that is configured to be operatively connectable, through wired or wireless communication, to a corresponding communication port on the vehicle. The DAT 10 may additionally include a processor and a memory with computer executable instructions stored thereon, that when executed by the processor facilitate the various functionalities described herein. For more information regarding the DAT 10, please refer to U.S. Pat. No. 9,824,507, entitled MOBILE DEVICE BASED VEHICLE DIAGNOSTIC SYSTEM, and U.S. Pat. No. 11,158,141, entitled SYSTEM AND METHOD FOR PROACTIVE VEHICLE DIAGNOSIS AND OPERATIONAL ALERT, both of which are owned by Innova Electronics Corp., the assignee of the present disclosure, and the contents of which are expressly incorporated herein by reference. Furthermore, examples of a DAT 10 include, but are not limited to, the 5510 CarScan Tech, the 7111 Smart Diagnostic System—OBD2 Tablet, and the 1000 CarScan Mobile, all sold by Innova Electronics Corp.

An ECU status request signal may be generated by the DAT 10 and transmitted to the vehicle network via the diagnostic port on the vehicle once the DAT 10 is operatively connected to the vehicle. The ECU status request signal may include instructions or commands executable by the vehicle to collect information regarding the status of active or responsive on-board computers (e.g., ECUs) included in the vehicle network. Subsequently, a status response signal may be received by the DAT 10 from the vehicle network, with the response signal including response information from active on-board computers. The on-board computers included in the status response signal may be referred to as a first group of on-board computers In this regard, any on-board computer that may be inactive for any reason may send no response signal due to their inactive status.

The data received from the vehicle may be used to compile, derive, or construct a network state-of-health, which may identify all on-board computers as having either an active status or an inactive status. The active computers may be identified using the response signal received from the vehicle. The inactive computers may be identified using a comprehensive list of all on-board computers associated with the vehicle under test and comparing that list with a list of active computers. The comprehensive list may be obtained using vehicle identification information (e.g., year, make, model, engine; vehicle identification number; etc.) that may be retrieved from the vehicle, such as an electronic vehicle identification number (VIN), acquired by the user, such as scanning a barcode on the vehicle associated with the vehicle's VIN or taking a picture of the VIN or license plate which may be used to derive vehicle identification information. It is also contemplated that the vehicle identification information may be entered by the user into a user interface on the DAT 10 or via a kiosk 12 associated with the DAT 10 or via a smartphone or other handheld communication device 14 in communication with the DAT 10 or one or more remote servers 16 having access to software and/or data needed to implement the functionalities described herein. For more information regarding the use of a kiosk 12 or handheld communication device 14 in connection with a vehicle diagnostic process, please refer to U.S. Patent Application Publication No. 2021/0279978 entitled KIOSK BASED VEHICLE DIAGNOSTIC SYSTEM, owned by Innova Electronics Corporation, the contents of which are expressly incorporated herein by reference. The vehicle identification information may be used to access a database having comprehensive lists sorted by vehicle identification information to identify the comprehensive list associated with the vehicle under test. In this regard, the database may be located on the DAT 10, on a handheld communication device in communication with the DAT 10, or on a remote server in communication with the DAT 10. It is also contemplated that the vehicle may supply the comprehensive list.

Those on-board computers that are on the comprehensive list, but not on the list of active computers may be considered the inactive on-board computers. Properties, such as function and location of each on-board computer may be known, and thus, both the active and inactive computers may be sorted into their respective network groups in a state-of-health report. The state-of-health report may serve as a reference point for subsequent data queries.

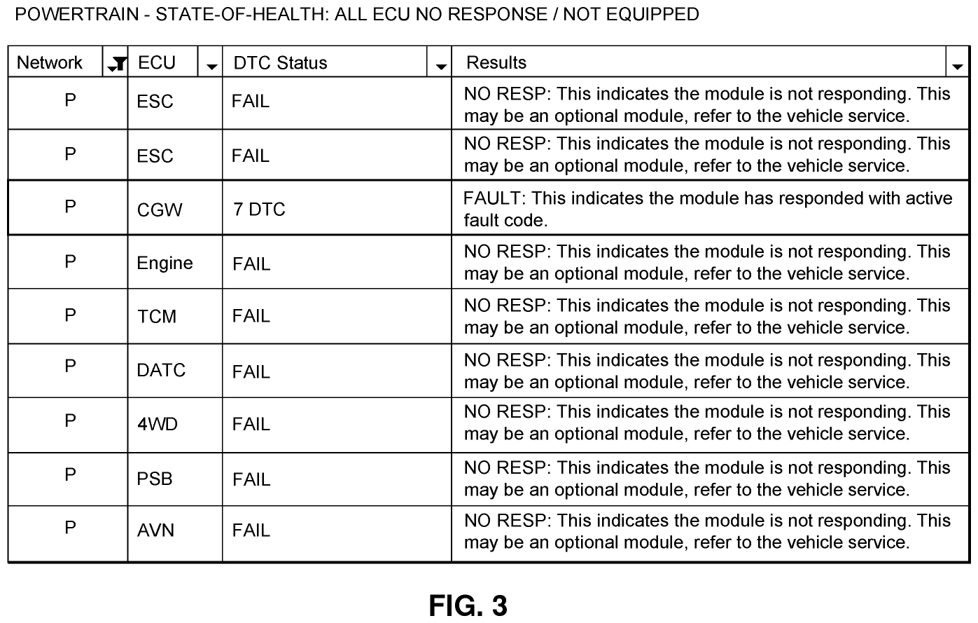

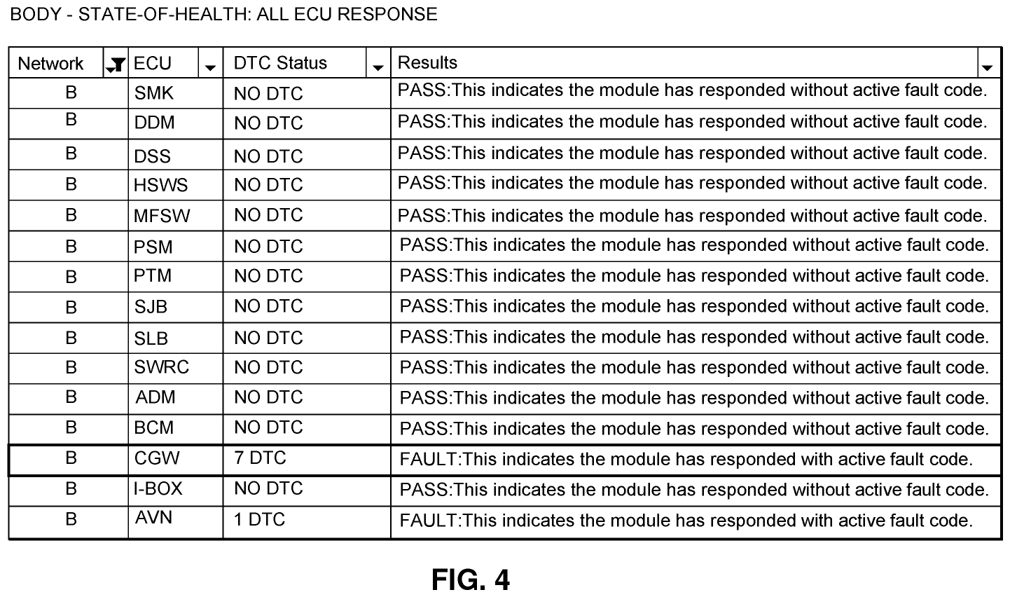

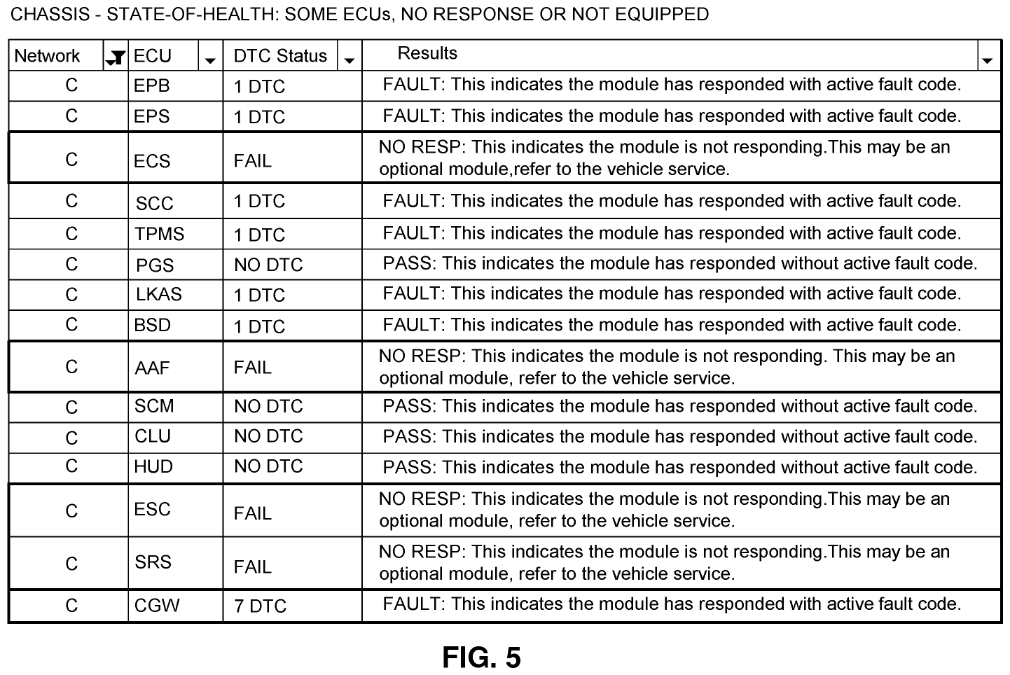

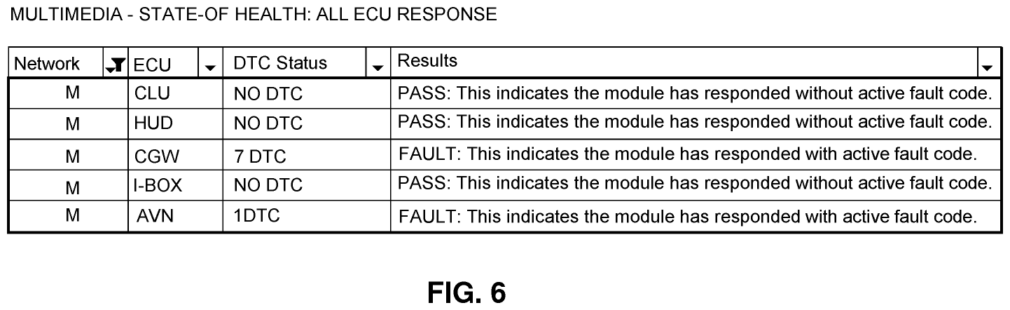

FIGS. 3-6 depict exemplary state-of-health sub-reports organized by network groups. In particular, FIG. 3 shows a Powertrain portion of the state-of-health, FIG. 4 shows a Body portion of the state-of-health, FIG. 5 shows a Chassis portion of the state-of-health, and FIG. 6 shows a Multimedia portion of the state-of-health. The state-of-health of each network group may range from all ECU's not responding or not being equipped (See Powertrain— FIG. 3), to all ECU responding (See Body—FIG. 4 and Multimedia—FIG. 6), to some ECUs responding, while others not responding (See Chassis— FIG. 5).

Looking in more detail again at FIG. 3, the Powertrain portion of the state-of-health shows that all of the various ECUs associated with the Powertrain network show no response, except for the CGW (i.e., central gateway) ECU. Note that the CGW may not be unique to the Powertrain network, and thus, faults associated therewith (e.g., 7 DTCs) may not be associated with the Powertrain network, whereas, the remaining ECUs listed in the Powertrain state-of-health may be unique to the Powertrain network, and their failure to respond may be indicative of a problem with the Powertrain network, as will be discussed in more detail below.

Looking in more detail now at FIG. 4, the Body portion of the state-of-health shows that all of the ECUs unique to the Body network provided a response, and thus, are active. The CGW ECU appears again in the same manner as the Powertrain portion of the state-of-health, due to the CGW also being associated with the Body network. The AVN ECU reports 1 DTC, while all other ECUs report no DTCs.

Looking in more detail now at FIG. 5, the Chassis portion of the state-of-health shows that some of the ECUs unique to the Chassis network provided a response, and thus, are active, while other ECUs unique to the Chassis network did not provide a response, and thus are inactive or not equipped on the vehicle under test. In this regard, the database including the listing of ECUs associated the vehicle under test used to compile the state-of-health may include ECUs that may not be equipped on the vehicle under test. For instance, some vehicles of the same year and make may include a different grouping of ECUs on a particular network, i.e., a first vehicle may include a first group of ECUs on a particular network, while a second vehicle may include a second group of ECUs on that particular network. There may be significant overlap with the first and second group of ECUs (e.g., in some cases only differing by one or two ECUs), however, the comprehensive listing included in the state of health includes each ECU included in both the first group and the second group. It is contemplated that the comprehensive listing of ECUs may be compiled from any number of ECU groups (e.g., more than two) without departing from the spirit and scope of the present disclosure.

The Chassis ECUs that responded include a combination of some ECUs with no reported DTCs, while other ECUs responded with 1 DTC. The CGW ECU appears again in the same manner as the Powertrain portion of the state-of-health, due to the CGW also being associated with the Chassis network.

Looking in more detail now at FIG. 6, the Multimedia portion of the state-of-health shows that all of the ECUs unique to the Multimedia network provided a response, and thus, are active. The CGW ECU appears again in the same manner as the Powertrain portion of the state-of-health, due to the CGW also being associated with the Multimedia network. The AVN ECU reports 1 DTC, with the AVN ECU also appearing on the Powertrain and Body state of health reports. As you will note, the AVN ECU on the Powertrain portion of the state-of-health reflects a fail status, while the AVN on the Body and Multimedia portions of the state-of-health reflects a received DTC. This discrepancy may be the result of the Powertrain network being down, and thus, ECUs along that network may not be communicating. However, the Body, Chassis and Multimedia networks may remain operational, and thus, the AVN ECU may communicate on those networks.

Once the state-of-health report is generated, fault codes may be retrieved from the vehicle using the DAT 10. The received fault codes may be sorted or categorized based on the origin (e.g., location) of each fault code as well as the time when each fault code was triggered. With regard to origin, each fault code may be categorized as being either a network type fault code or a non-network type fault code. With regard to timing, each fault code may be classified as being either active, pending, or historical. For purposes of further analysis in the diagnostic method and system disclosed herein, it is the active network type fault codes that may be of particular interest, and thus, those fault codes may be filtered or separated from the rest. Moreover, the active fault codes may be further classified or categorized into one of the following groups: Message Error, Time-Out, or Bus-Off. Each received active fault code may be associated with an on-board computer, with the group of on-board computers associated with the received active fault codes being referred to as a second group of on-board computers.

The Message Error group may include fault codes recorded when one ECU receives a response from another ECU, with the data in the received response being invalid or corrupt. The Time-Out group may include fault codes recorded when an ECU did not receive a response from another ECU. The Bus-Off group may include fault codes that have been recorded when an ECU no longer can maintain communication and stops sending and receiving messages.

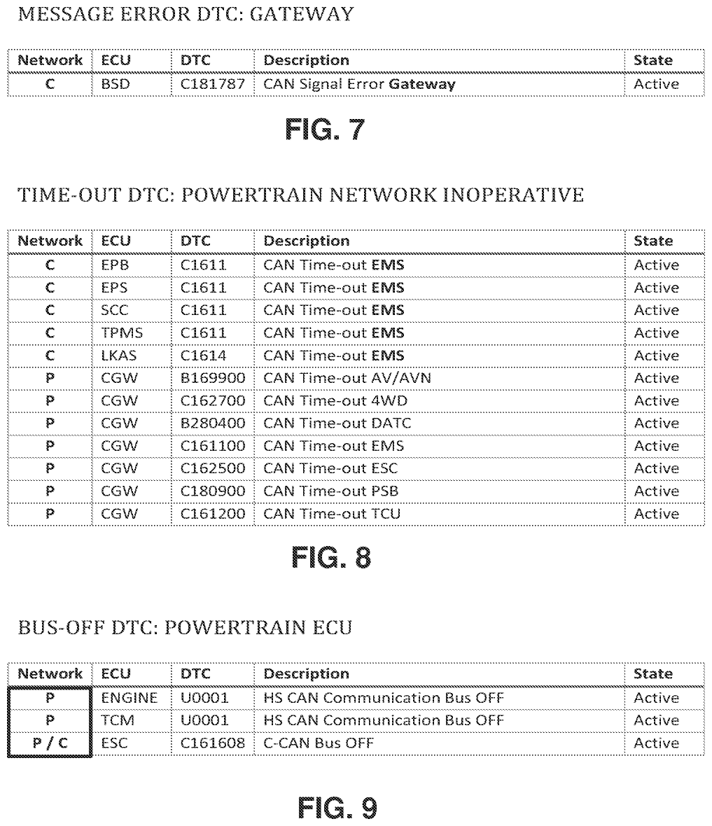

FIG. 7 shows an example of a received Message Error DTC, which was generated by the BSD ECU associated with the Chassis Network. In particular, the received DTC is associated with a CAN signal error, and more specifically, that a message from the CGW ECU includes corrupt or invalid data, indicative of a problem.

FIG. 8 is an exemplary chart including received Time-Out DTCs. As can be seen, the DTCs within the chart are each associated with an ECU from which the DTCs are generated. The chart depicted in FIG. 8 groups the ECUs based on their associated network. The first five rows of the chart include ECUs included in the Chassis network, while the remaining rows in the chart include ECUs included in the Powertrain network. All of the DTCs generated by Chassis ECUs all refer to a CAN Time-Out with communication with the EMS (Engine Management System). The DTCs associated with the Powertrain network were all generated by the CGW ECU and relate to CAN Time-out with various ECUs included in the Powertrain network, e.g., AVN/PGS, 4WD, DATC, EMS, ESC, PSB, and TCU. In this regard, the ECUs are indicative of the CGW having not received a signal from the aforementioned ECUs.

After having received the DTCs associated with the Powertrain network, the Powertrain state-of-health may be referenced review the DTC status for those Powertrain ECUs. This comparison reveals that all of the Powertrain ECUs that received Time-Out DTCs were also listed in the State of Health as being non-responsive. Thus, it can be concluded that these ECUs are indeed located on the vehicle based on those ECUs being associated with specific Time-Out DTCs received by the DAT. However, each of those DTCs is associated with one or more underlying issues. Given that many of the Powertrain ECUs were associated with a Time-Out DTC, it is indicative of a possible problem associated with the Powertrain network being inoperative.

FIG. 9 is an exemplary chart of Bus-Off DTCs that have been received from the ECUs listed in the second column, i.e., the Engine ECU, TCM ECU and ESC ECU. Bus-Off DTCs may refer to an ECU unable to communicate on internal or external CAN lines for a prescribed period of time (e.g., two seconds), which triggers the DTC. In the example depicted in FIG. 9, all of the ECUs that generated a Bus-Off DTC are associated with the Powertrain network, with the ESC ECU also being associated with the Chassis network.

According to one embodiment, a primary probable cause may be found by using an algorithm that queries probability based off frequency of faults, the number of faults, and the types of faults. The active DTCs may be initially evaluated and then historical DTCs may be evaluated. The historical DTCs may be associated with a “secondary” probable cause, which may be used to place higher probability on the primary probable cause results.

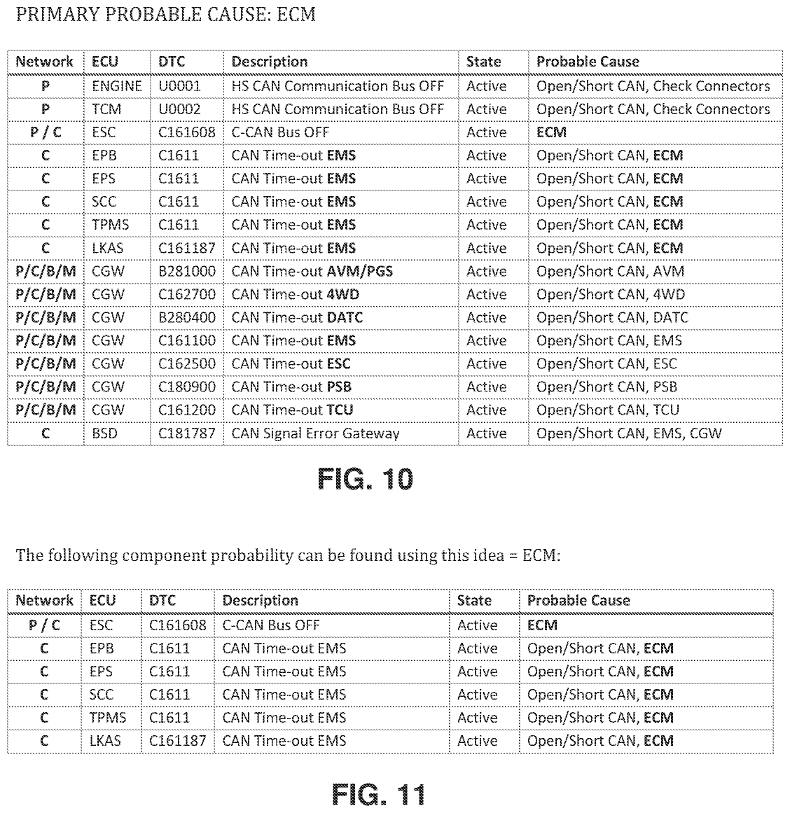

FIG. 10 is single chart combining all of the DTCs shown in FIGS. 7-9 to illustrate how a primary probable cause may be determined. The chart in FIG. 10 not only includes a comprehensive listing of all of the DTCs from FIGS. 7-9, but also includes a column on the right which lists a probable cause for each ECU. The most common probable cause listed in FIG. 10 is the ECM, and thus, because it is the probable cause that appears the most (e.g., it is associated with more DTCs than any other probable cause), it may be identified as the primary probable cause.

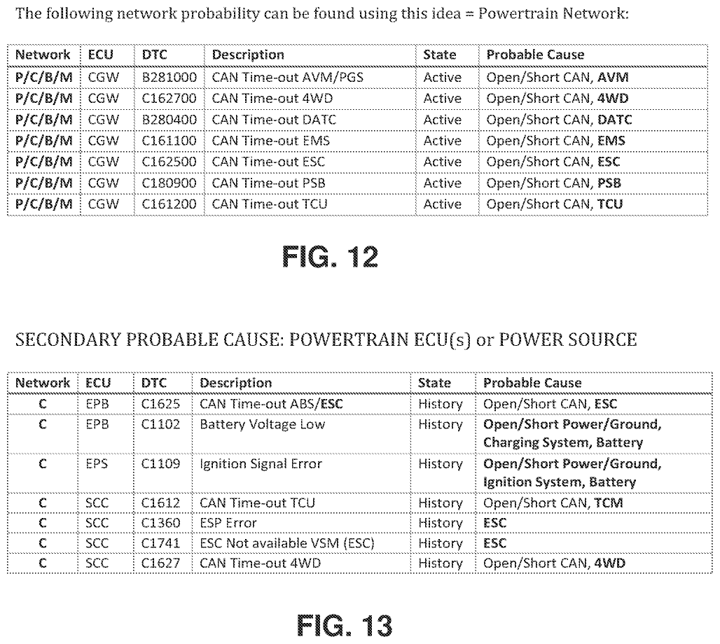

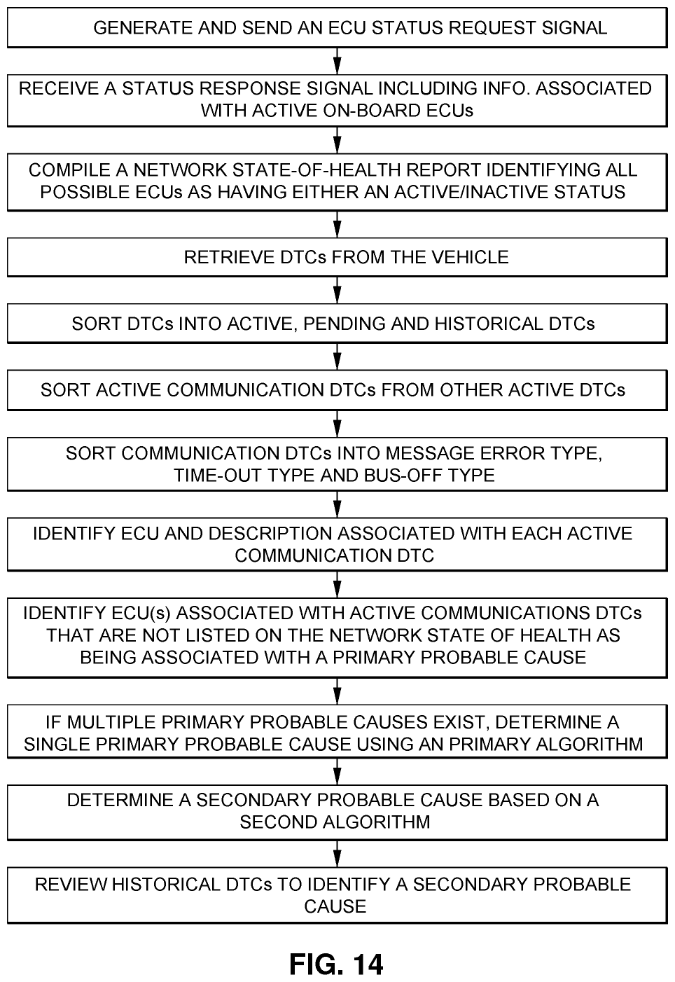

It is contemplated that the primary probable cause may be categorized by a component and/or a network. FIG. 11 shows information leading to a component primary cause of the ECM. All of the information in FIG. 11 is taken from FIG. 10, and is based on the ECM being the highest frequency component listed in the probable cause column of FIG. 10. FIG. 12 shows information leading to a network primary cause of the Powertrain network. In this regard, the information in FIG. 12 is derived from FIG. 10 and illustrates that the Powertrain network is associated with the highest number of faults.

The secondary probable cause may be found using an algorithm that queries probability based off frequency of faults, the number of faults, and the types of faults. Identifying a secondary probable cause may strengthen the primary probable cause. Consequently, historical DTC results or secondary probable causes may enhance or strengthen the probability of the primary probable cause results.

FIG. 13 is an exemplary chart, which shows possible secondary probable causes of the Powertrain network, an open/short power/ground, charging system, battery and/or ignition.

Therefore, in summary, the state-of-health query reports: P-CAN is down—no ECU responded with CGW ECU responding with 7 DTCs. B-CAN is operational—all ECUs responded with CGW ECU responding with 7 DTCs. C-CAN is operational—15 ECUs' responded, 3 down or NOT equipped, CGW with 7 DTCs. M-CAN is operational—all ECUs responded. CAN DTC message query and parsing algorithm applied, the probable cause is either the ECM is defective, and/or, the power source to the Powertrain Network is dead.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A vehicle diagnostic method based on an analysis of communication signals on a vehicle having a plurality of electronic control units (ECUs), the vehicle diagnostic method comprising the steps of:
transmitting an ECU status request signal to the vehicle;
receiving a status response signal from the vehicle, the status response signal including a plurality of ECUs on the vehicle being responsive to the transmitted ECU status request signal;
generating a state of health report including a comprehensive listing of all ECUs associated with the vehicle, each ECU in the state of health report responsive to the transmitted ECU status request signal being associated with an active status, the remaining ECUs in the state of health report being associated with an inactive status;
receiving communication DTCs from the vehicle, each communication DTC being associated with at least one ECU; and
identifying a primary probable cause ECU as being one of the ECUs associated a received communication DTC that is also associated with an inactive status.

2. The method recited in claim 1, further comprising the step of receiving historical DTCs from the vehicle.

3. The method recited in claim 2, further comprising the step of determining a secondary probable cause based on an analysis of the historical DTCs.

4. The method recited in claim 1, wherein the step of generating the state of health report includes organizing all of the ECUs according to associated communication networks on the vehicle.

5. The method recited in claim 4, wherein the associated communication networks include a powertrain network, a body network, a chassis network, and a multi-media network.

6. The method recited in claim 1, wherein the step of receiving communication DTCs includes receiving a message error DTC, a time-out DTC and a bus-off DTC.

7. The method recited in claim 6, wherein the step of identifying a primary probable cause includes identifying a communication network or an ECU associated with a highest number of received communication DTCs.

8. The method recited in claim 1, further comprising the steps of receiving non-communication DTCs and filtering the received communication DTCs from the non-communication DTCs.

9. The method recited in claim 1, further comprising the step of requesting data associated with the probable cause.

10. A handheld automotive diagnostic device configured for diagnosing a vehicle based on communication signals on the vehicle, the handheld automotive diagnostic device comprising:
a memory circuit having computer executable instructions stored thereon, which when executed, cause the diagnostic device to:
transmit an ECU status request signal to the vehicle;
receive a status response signal from the vehicle, the status response signal including a plurality of ECUs on the vehicle responsive to the transmitted ECU status request signal;
generate a state of health report including a comprehensive listing of all ECUs associated with the vehicle, each ECU in the state of health report responsive to the requested ECU status signal being associated with an active status, the remaining ECUs in the state of health report being associated with an inactive status;
receive communication DTCs from the vehicle, each communication DTC being generated by one of the plurality of ECUs associated with an active status and each communication DTC also being associated with a possible problematic ECU; and
identify a primary probable cause ECU as being one of the ECUs associated with an inactive status and also one of the possible problematic ECUs.

11. The handheld automotive diagnostic device recited in claim 10, wherein the computer executable instructions stored on the memory circuit, when executed, further cause the diagnostic device to receive historical DTCs from the vehicle.

12. The handheld automotive diagnostic device recited in claim 11, wherein the computer executable instructions stored on the memory circuit, when executed, further cause the diagnostic device to determine a secondary probable cause based on an analysis of the historical DTCs.

13. The handheld automotive diagnostic device recited in claim 10, wherein generating the state of health report includes organizing all of the ECUs according to associated communication networks on the vehicle.

14. The handheld automotive diagnostic device recited in claim 13, wherein the associated communication networks include a powertrain network, a body network, a chassis network, and a multi-media network.

15. The handheld automotive diagnostic device recited in claim 10, wherein receiving communication DTCs includes receiving a message error DTC, a time-out DTC and a bus-off DTC.

16. The handheld automotive diagnostic device recited in claim 15, wherein identifying a primary probable cause includes identifying a communication network or an ECU associated with a highest number of received communication DTCs.

17. The handheld automotive diagnostic device recited in claim 10, wherein the computer executable instructions stored on the memory circuit, when executed, further cause the diagnostic device to receive non-communication DTCs and filter the received communication DTCs from the non-communication DTCs.

18. The handheld automotive diagnostic device recited in claim 10, wherein the computer executable instructions stored on the memory circuit, when executed, further cause the diagnostic device to request data associated with the probable cause.

19. A vehicle diagnostic method based on an analysis of communication signals on a vehicle having a plurality of electronic control units (ECUs), the vehicle diagnostic method comprising the steps of:
transmitting an ECU status request signal to the vehicle;
receiving a status response signal from the vehicle, the status response signal including a first group of ECUs on the vehicle that have responded to the transmitted ECU status request signal;
receiving communication DTCs from the vehicle, the communication DTCs being associated with a second group of ECUs; and
identifying a primary probable cause ECU by comparing the second group of ECUs to the first group of ECUs, the primary probable cause ECU being included in the second group of ECUs and not in the first group of ECUs.

20. The method recited in claim 19, further comprising the steps of:
receiving historical DTCs from the vehicle; and
determining a secondary probable cause based on an analysis of the historical DTCs.
